(19) United States
(12) Patent Application Publication
(10) Pub. No.: US 2024/0012090 A1
(43) Pub. Date: Jan. 11, 2024

(54) ULTRA WIDEBAND AI-ENHANCED IMU TRACKING SYSTEM FOR FIRST RESPONDER USE WITH SMART GLASSES

(71) Applicant: ThirdEye Gen, Inc, Princeton, NJ (US)

(72) Inventor: Nick Cherukuri, Princeton, NJ (US)

(73) Assignee: ThirdEye Gen, Inc, Princeton, NJ (US)

(21) Appl. No.: 17/859,174

(22) Filed: Jul. 7, 2022

(51) Int. Cl. G01S 5/02; G01S 19/49

(52) U.S. Cl. CPC G01S 5/02685; G01S 19/49

(57) ABSTRACT

A tracking system that works through walls, below grade, and at long range is provided, which may be utilized as a first responder tracking system. The system combines UWB (Ultrawideband) with AI-enhanced IMU motion tracking with use on, e.g., android-based smart glasses, phones and tablets. The UWB tracking provides a stable reference point in GPS denied environments, offering 3D tracking under the most challenging conditions. When walls or distance make UWB untenable, disclosed tags stream back IMU data processed by machine learning algorithms which remove, e.g., the effect of drift, noise, and error common to motion-based tracking. The system may process the UWB and IMU input data and produce a platform and language agnostic serialized message stream with position data. This published stream allows any visualization platform to subscribe and consume 3D position data, be it a local graph for engineering debug, cloud-based first responder software, or a third-party solution.

### TECHNICAL FIELD

The present disclosure is drawn to the field of tracking systems, and specifically, tracking systems for GP S-denied environments.

### BACKGROUND

Modern first response teams require knowing where first responders are at any given point in time. Being able to accurately locate where a given first responder is allows for faster responses or better tactics when responding to an emergency.

Conventional use of Global Positioning System (GPS)-based tracking has many limitations. One limitation that is critical is that in many situations, such as when a person is indoors, GPS either does not function, or cannot function accurately.

To overcome these limitations, numerous work-arounds have been tried, including, utilizing signals of opportunity such as Wi-Fi, TV, and LTE radio signals, to better triangulate the position of an individual, even in environments where GPS is denied (e.g., in a house, underground, etc.). However, to date, none of these systems can consistently provide accurate locations of an individual in GPS-denied environments.

### BRIEF SUMMARY

To provide accurate locations in signal-denied environments (such as GPS-denied environments), in some embodiments, a system for tracking locations may be provided. The system may include an ultrawideband (UWB) tag operably coupled to a target, where the UWB tag may be configured to operably communicate with a remote processor. The system may include an inertial measurement unit (IMU) operably coupled to the target, where the IMU is configured to operably communicate with the remote processor. The system may include a non-transitory computer readable storage medium containing instructions that, when executed, configured the remote processor to (1) receive position data of the UWB tag and receive raw IMU data from the IMU; (2) create prepared IMU data for use with a trained algorithm by processing the raw IMU data; (3) generate corrected IMU data by using the trained algorithm to remove at least some drift, noise, and/or error from the prepared IMU data; (4) determine a confidence in the position data, and based on the confidence, combine position data and corrected IMU data to provide an estimate of a location of the target; and (5) generate a message in a serialized message stream containing the estimate of the location of the target. In some embodiments, the message may contain the estimate of the location of the target, as well as additional information, such as a unique identifier associated with the target.

In some embodiments, the system may include a UWB anchor, where the UWB tag may be configured to communicate with the UWB anchor, and the UWB anchor may be configured to communicate directly or indirectly with the remote processor.

In some embodiments, the UWB tag and the IMU may be incorporated in a single device. In some embodiments, the single device may be an augmented reality (AR) headset or AR glasses (which may include, e.g., at least one processor operably coupled to the UWB tag, the IMU, and a display, where the display is operably coupled to a headset configured to be placed in front of a user's eyes). In some embodiments, the single device may be a smartphone or tablet. In preferred embodiments, the single device is an Android-based device (e.g., a device using an Android operating system). In some embodiments, the single device may include a radio with a range of 3-10 miles line-of-sight, and a bandwidth less than 30 kbits/sec.

In some embodiments, a second AR headset or AR glasses may be configured to receive the serialized message stream and graphically display a position of the target on a display of the second AR headset or AR glasses.

In some embodiments, the position data and raw IMU data are sent to the remote processor over a ZMQ socket.

In some embodiments, the remote processor receives position data once every 1-10 seconds and raw IMU data once per second.

In some embodiments, creating prepared IMU data includes: (1) storing the raw IMU data in a concurrent queue; (2) generating intermediate IMU data by pre-processing the raw IMU data from the concurrent queue in two-second chunks and applying a rotation vector to the raw IMU data to render it invariant to the IMU position; and (3) time-synchronizing and interpolating the intermediate IMU data.

In some embodiments, combining the position data and the corrected IMU data includes utilizing a Kalman filter.

In some embodiments, combining the position data and the corrected IMU data includes: (1) determining a confidence of the position data; (2) selecting only the position data when the confidence of the position data is greater than or equal to a threshold confidence; and (3) selecting only the corrected IMU data when the confidence of the position data is less than the threshold confidence.

In some embodiments, combining the position data and the corrected IMU data includes: (1) determining a confidence of the position data and a confidence of the corrected IMU data; (2) selecting only the position data when the confidence of the position data is greater than or equal to a first threshold confidence; (3) selecting only the corrected IMU data when the confidence of the position data is less than the first threshold confidence and the confidence of the corrected IMU data is greater than or equal to a second threshold confidence; and (4) utilizing a Kalman filter to combine the position data and the corrected IMU data when the confidence of the position data is less than the first threshold confidence and the confidence of the corrected IMU data is less than the second threshold confidence.

In some embodiments, the estimate of the location of the target may use an alignment reference of the position data as an alignment reference of the estimate of the location of the target. In some embodiments, the estimate of the location of the target may use global positioning system (GPS) data as an alignment reference of the estimate of the location of the target.

In some embodiments, the remote processor may be configured to: (1) receive global positioning system (GPS) data from a GPS sensor operably coupled to the target, or from a GPS sensor coupled to a vehicle; and (2) combine position data, corrected IMU data, and GPS data to provide an estimate of a location of the target.

In some embodiments, the system may include one or more remote devices. Each remote device may be configured to: (1) receive each message in the serialized message stream; and (2) graphically display the estimated of the location of the target. In some embodiments, one of the remote devices may be, e.g., an AR headset or AR glasses.

In some embodiments, a method may be provided for estimating locations. The method may include: (1) receiving position data from a UWB tag operably coupled to a target and receiving raw IMU data from an IMU; (2) creating prepared IMU data for use with a trained algorithm by processing the raw IMU data; (3) generating corrected IMU data by using the trained algorithm to remove at least some drift, noise, and/or error from the prepared IMU data; (4) combining position data and corrected IMU data to provide an estimate of a location of the target; and (5) generating a message in a serialized message stream containing the estimate of the location of the target.

In some embodiments, a kit may be provided. The kit may include a device containing a UWB tag and an IMU; a UWB anchor; and a gateway configured to be coupled to the UWB anchor and to communicate with a remote server using a ZMQ socket.

### BRIEF DESCRIPTION OF DRAWINGS

FIG. 1 is a block diagram of a system.

FIG. 2 is a block diagram of a UWB tag.

FIG. 3A is a block diagram of various components and their connections of an AR headset or AR glasses.

FIG. 3B is an illustration of a front perspective view of an AR headset or AR glasses.

FIG. 4 is a flowchart of a method.

FIG. 5 is a simplified block diagram of a system.

FIGS. 6A and 6B are graphs showing a comparison of outdoor-only location data using IMU-data only and UWB-data only; FIG. 6A uses a front door of a test home as a reference location, while FIG. 6B uses GPS data for reference.

FIGS. 7A and 7B are graphs showing a comparison of indoor and outdoor location data using IMU-data only and UWB-data only; FIG. 6A uses a front door of a test home as a reference location, while FIG. 6B uses GPS data for reference.

FIG. 8A is a graph showing UWB location data from a test where a target walked indoors in a loop multiple times.

FIG. 8B is a graph showing IMU location data from a test where a target walked indoors in the same loop as in FIG. 8A multiple times; the uncorrected drift from the IMU data can be seen.

FIG. 9 is a graph showing estimated locations based on corrected IMU data compared to ground truth.

FIG. 10 is an illustration of an example graphical user interface.

### DETAILED DESCRIPTION

In some embodiments, a system for tracking locations may be provided. Conventional tracking systems that utilize ultrawideband and IMU data, such as those described in, e.g., PCT/US2017/022376 and U.S. Pat. No. 9,945,929 (the entirety of which are incorporated by reference herein in their entirety), rely on having sensors that always have access to reference signals (e.g., UWB tags are always in range of a UWB signal from a reference point or anchor). The fusion of data allows the conventional systems to improve UWB location estimations by also including IMU data. However, In such conventional systems, if no UWB signal is received, the system cannot estimate a location.

The presently disclosed systems improve upon these conventional systems by allowing the system to select and/or weight the IMU data when determining location, based on a determined confidence in the UWB signals. This is made possible by, e.g., having a trained AI model process the raw IMU data to remove at least some drift, noise, and/or error. If the drift, noise, and/or error are not eliminated, a few changes in direction and/or velocity would result in a completely inaccurate location estimate whenever UWB signals were not available.

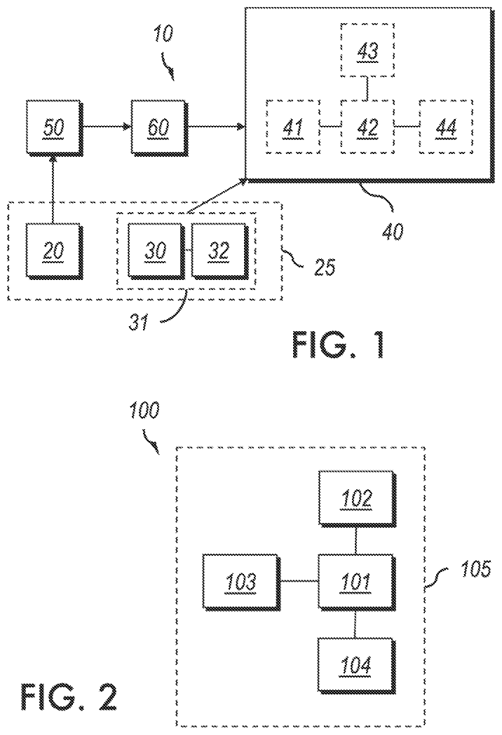

Referring to FIG. 1, in some embodiments of a system 10, the system may include a UWB tag 20, an IMU 30, a remote processor 42, and a non-transitory computer readable storage medium 44.

UWB Tag

The UWB tag 20 may be operably coupled to a target 25. The UWB tag may be configured to operably communicate with the remote processor 42. UWB tags are well-known in the art. A non-limiting example of a UWB tag can be seen with reference to FIG. 2.

In FIG. 2, the example tag 100 includes a processor 101, memory 102, one or more timing devices 103, and a communication interface 104. In some embodiments, the tag may be surrounded by a housing 105. Example tags may be implemented using any desired combination of hardware, firmware, and/or software.

The processor 101 may be implemented using any processor or controller suitable for controlling the tag and managing or processing data related to detecting the location of the tag. The processor 101 may be configured to perform and control various operations and features of the tag, such as, e.g., managing communications.

The memory 102 stores software/firmware instructions for controlling the operations of the tag. In addition, the memory can be used to store profile information identifying the tag and can also store any data collected by the tag. The memory may be implemented using any suitable volatile and/or non-volatile memory including a random-access memory (RAM), a read-only memory (ROM), a flash memory device, a hard drive, an optical storage medium, etc. In addition, the memory may be any removable or non-removable storage medium.

The timing device(s) 103 may, e.g., implement any timing operations. The one or more timing devices may be implemented using a clock (e.g., a real-time clock), a timer, a counter, or any combination thereof. Although the timing device(s) is shown in FIG. 2 as separate from the processor, in some example implementations the timing device(s) may be integrated with the processor.

The communication interface 104 (which may include, e.g., one or more transceivers) is configured to communicate information between the tag and another processor systems (such as a UWB anchor) using, e.g., ultrawideband signals, Long Range (LoRa) radio signals, 4G/5G signals, etc., as appropriate.

As is known in the art, typically, a UWB tag is part of a UWB system. The UWB system will include one or more UWB anchors 50 (each of which contains a receiver for receiving UWB signals). Here, the UWB anchors are operably connected to, e.g., one or more processors 60 and a memory. The one or more processors may be, e.g., in a ruggedized or industrialized computer. In some embodiments, the UWB anchors are mounted on a vehicle, such as a fire engine, police car, etc. In some embodiments, the system may include a UWB anchor, where the UWB tag may be configured to communicate with the UWB anchor, and the UWB anchor may be configured to communicate directly or indirectly with the remote processor.

In some embodiments, the system is set up to use a time difference of arrival (TDoA) approach—the tag 20 periodically sends out a transmission, which is captured by each anchor point 50 and timestamped, then sent to the one or more processors 60, after which the computer determines a position of the tag based on the timestamps of when each anchor received the transmission.

If a transmission utilizes the IEEE 802.15.4 standard, typically timestamping is based on a symbol being detected, where the timestamp is the point at which the transmitted signal changes from the repeated transmission of a preamble code to the transmission of the start-of-frame delimiter.

In some embodiments, the system is set up to us a reverse TDoA approach, where the anchors 50 each periodically send out a transmission (with fixed/known offsets to avoid collisions), which is captured by the tag 20, and the tag (or, e.g., a processor coupled to the tag) determines a position of the tag based on a timestamp of when the tag receives transmissions from each anchor.

In some embodiments, the system is set up to use a phase difference of arrival (PDoA) approach. Here, the tag 20 communicates with at least one other device (such as a UWB anchor 50, or another AR headset or glasses configured with a UWB configured for PDoA, etc.). Either the tag or the device must be equipped with at least 2 antennas and be able to measure the phase difference of the arriving signal carriers at each antenna. The phase is completely independent of the antenna distortion and measurement accuracy of better than 10° can be achieved, allowing the determination of the transmitter's orientation in less than 5°. If the tag communicates with two or more devices, the degree of accuracy increases further.

IMU

Referring to FIG. 1, the IMU 30 may be operably coupled to the target 25. The IMU may be configured to operably communicate with the remote processor 42. As is known in the art, an IMU may include multiple sensors, including, e.g., accelerometers, gyroscopes, magnetometers, barometers, and/or GPS.

In some embodiments, the IMU is positioned within a housing 31, and may be operably coupled to one or more other components 32. Other components may include, e.g., a wireless transceiver, a display, etc.

In some embodiments, the IMU and the UWB tag may be in a single device. In some embodiments, the single device is an Android-based device (e.g., a device using an Android operating system).

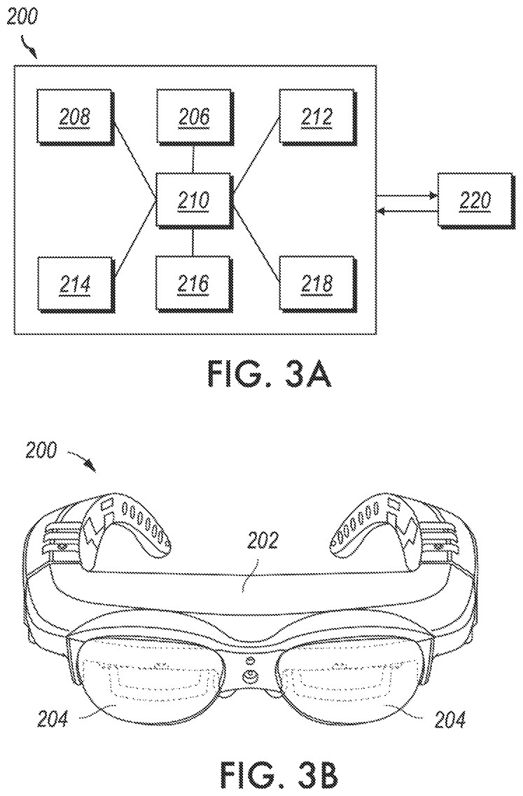

In some embodiments, the IMU and/or UWB tag is a component in a smartphone or tablet. In some embodiments, the IMU is coupled to an AR headset or AR glasses. In some embodiments, both the IMU and the UWB tag are coupled to an AR headset or AR glasses. AR headsets and glasses are well-known in the art. A non-limiting example of an AR headset or AR glasses can be seen with reference to FIGS. 3A and 3B.

Referring to FIGS. 3A and 3B, the AR headset or AR glasses may include a frame 202 supporting a glasses lens/optical display 204, which is configured to be worn by the user. The frame 202 is associated with a processor. In some embodiments, AR headset or AR glasses may include a processor 210, such as a qualcomm xrl processor which contains 4 GB RAM, 64 GB storage, an integrated cpu/gpu and an additional memory option via usb-c port. The processor may be located on, e.g., the left-hand side arm enclosing of the frame and shielded with protective material to dissipate the processor heat. Generally, the processor 110 may be configured to synchronize data (such as the IMU data) with camera feed data, to provide a seamless display of 3D content of the augmented reality application 220. The optical display 204 may be coupled to the processor 210 and a camera PCB board. In some embodiments, an IMU and/or UWB tag may be present in or on any portion of the frame. For example, in some embodiments, the IMU and UWB tag are positioned above the display 204.

A sensor assembly 206 may be in communication with the processor 210.

A camera assembly 208 may be in communication with the processor and may include, e.g., a 13-megapixel RGB camera, 2 wide angle grey scale cameras, a flashlight, an ambient light sensor (ALS) and a thermal sensor. All these camera sensors may be located on the front face of the headset or glasses and may be angled, e.g., 5 degrees below horizontal to closely match the natural human field of view.

A user interface control assembly 212 may be in communication with the processor 210. The user interface control assembly may include, e.g., audio command control, head motion control and a wireless Bluetooth controller which may be coupled to, e.g., an android wireless keypad controlled via a built-in Bluetooth BT 5.0 LE system in the xrl processor. The head motion control may utilize a built-in android IMU sensor to track the user's head movement via three degrees of freedom, i.e., if a user moves their head to the left the cursor moves to the left as well. The audio commands may be controlled by, e.g., a three-microphone system located in the front of the glasses that captures audio commands in English. These different modes of UI allow the user to pick and choose their personal preference for UI.

In some embodiments, the single device may include a radio in communication with the processor 210, the radio having a range of 3-10 miles line-of-sight, and a bandwidth less than 30 kbits/sec. In some embodiments, the radio is a Long Range (LoRa) radio.

A fan assembly 214 may be in communication with the processor 210, wherein the fan assembly 214 is synchronized to speed up or slow down based on the processor's heat.

A speaker system or speaker 216 may be in communication with the processor 210. The speaker system or speaker may be configured to deliver audio data to the user via the communication unit

A connector port assembly 218 may be in communication with the processor. The connector port assembly may have, e.g., a mini-jack port and a Universal Serial Bus Type-C (USB-C) port. The connector port assembly 218 allows users to insert their manual audio headphones. The USB-C port allows the user to charge the device or data-transfer purposes. In one embodiment, the frame 202 is further integrated with a wireless transceiver coupled to the processor 210.

Remote Processor

The remote processor 42 may be implemented using any physical processor suitable for processing incoming signals, utilizing a machine-learning algorithm, and creating messages for a serialized message stream. The processor may be operably coupled to a communication interface 41 (for receiving, e.g., data regarding position of the UWB tag and the IMU data), a memory 43, and the non-transitory computer-readable storage medium 44. In some embodiments, the processor is within a housing 40, such as within a cloud-based server.

Non-Transitory Computer Readable Storage Medium

The system may include a non-transitory computer readable storage medium 44 containing instructions that, when executed, configure the remote processor 42 to perform specific tasks in the overall process.

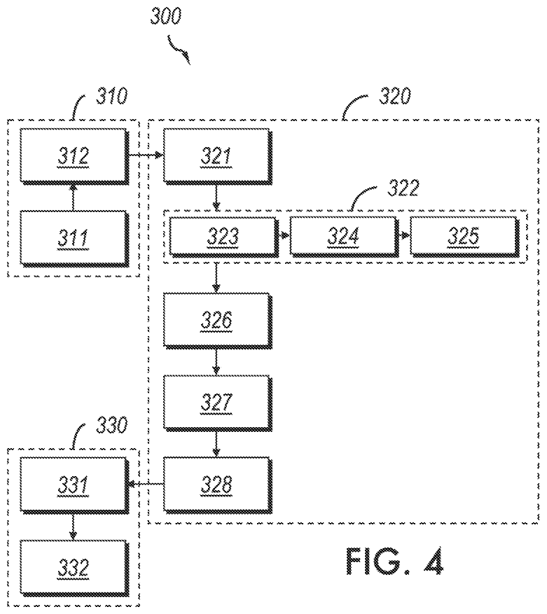

The general method used by this system can be described with reference to FIG. 4.

In FIG. 4, the method 300 is shown as including multiple groups of steps 310, 320, 330, each of which may be performed by a different component of the system.

The first group of steps 310 is typically performed by the device or devices coupled to the user (e.g., the UWB system as disclosed herein, the IMU, etc.).

First the system may determine 311 a location and collects data. As part of this step, the UWB system may determine a position of the UWB tag, and the IMU may gather raw data from its sensors (e.g., accelerometers, gyroscopes, barometers, GPS, etc.). In some embodiments, the IMU may also process some or all of the raw data. In some embodiments, a separate GPS sensor operably coupled to the target may be provided.

The second step involves sending 312 the position of the UWB tag and the raw IMU data to the remote processor. In some embodiments, a processor associated with the UWB tag may be configured to send the position data. In some embodiments, one or more processors (e.g., one or more processors 60) associated with the UWB anchors may be configured to send the position data. In some embodiments, a processor associated with the IMU may be configured to send the raw IMU data. In some embodiments, the raw IMU data may include accelerometer data, and gyroscope data. In some embodiments, the raw IMU data may include accelerometer data, gyroscope data, and barometer data. In some embodiments, the raw IMU data may include acceleratometer data, gyroscope data, barometer data, and GPS data. In some embodiments, GPS data (e.g., from a separate GPS sensor coupled to the target) is sent along with the position data from the UWB tag, and the IMU data. In some embodiments, UWB tag and raw IMU data are only sent in GPS-denied environments. For example, in some embodiments, if GPS data is determined to be reliable, only GPS data is sent, and if GPS data is determined to be unreliable, no GPS data is sent but raw IMU and UWB tag position data is sent.

In some embodiments, no barometer data is included. In one example, a test was performed with a barometer built into an android-based phone. Elevation was changed by walking to the second floor of a test home at a measured height change of 1.9 meters. A difference in pressure of 0.24 hPa was observed, equating to a height change of 2.03 meters. The actual measured height change was 1.98m. Switching to an even more accurate barometer should give better results.

However, one concern about the barometer approach is the air pressure difference in an active fire. The US Department of Commerce, Center for Fire Research published a study on Static Pressures Produced by Room Fires. Here they started a structure fire in a test room and observed a maximum pressure difference of 14 Pascals or 0.14 hPA. This difference equals a height variation of 1.1m when standing in a room on fire.

In some embodiments, an AI model may be trained using either camera data (e.g., seeing a room on fire), or data from a temperature sensor coupled to the target, to account for pressure differences caused by the environment in which the first responder is located.

In some embodiments, a processor associated with the IMU may be configured to send processed IMU data.

In some embodiments, the position data and raw IMU data are sent to the remote processor over a ZMQ socket.

The second group of steps 320 is typically performed by a remote processor.

The steps may include first receiving 321 position data of the UWB tag and raw IMU data from the IMU. In some embodiments, the remote processor receives position data once every 1-seconds and raw IMU data once per second.

In some embodiments, the remote processor may be also be configured to receive global positioning system (GPS) data from a GPS sensor operably coupled to the target, or from a GPS sensor coupled to a vehicle.

The steps may include creating 322 prepared IMU data for use with a trained algorithm by processing the raw IMU data. In some embodiments, creating 322 prepared IMU data includes storing 323 the raw IMU data in a concurrent queue. The data may have been received, e.g., via a communication, or via a sub-GHz radio.

In some embodiments, creating prepared IMU data includes generating 324 intermediate IMU data by pre-processing the raw IMU data from the concurrent queue in two-second chunks and applying a rotation vector to the raw IMU data to render it invariant to the IMU position (e.g., invariant to movement in the user's hand, pocket, etc.). This can be understood as using the rotation vector to un-rotate the phone. In some embodiments, this involves a quaternion at a synchronized point in time that represents the phone rotation so the system can take the inverse of that to correct it.

In some embodiments, creating prepared IMU data includes time-synchronizing and interpolating 325 the intermediate IMU data. This can be understood as a step for keeping all of the data aligned. Typically, in the IMU, the data is acquired from all sources (accelerometer, gyroscope, rotation vector, etc.) on the same timestamp. However, in some cases, some elements may be off, slightly, or perhaps (for example), the accelerometer may be measuring at 400 Hz, while the rotation is measured at 200 Hz. Sometimes, the raw data sample rate might vary by 0.1 ms or more. In some embodiments, all the sensor data in a given chunk (e.g., one of the two-second chunks) is gathered together, and then the data is sampled at exactly the sample rate (for example 100 Hz). Because that sample rate might not hit exactly on a value, the system will interpolate between the two nearest values to get the sample value.

The steps may include generate 326 corrected IMU data by using the trained machine-learning/artificial intelligence algorithm to remove at least some drift, noise, and/or error from the prepared IMU data. The algorithm has been trained to identify flaws in the intermediate IMU data resulting from, e.g., drift, noise, etc., and estimate what the correct data should be.

In some embodiments, the models may be trained by acquiring raw IMU data along with ground truth data in the real world. The data can be fed to a model that is configured to estimate location based on the raw IMU data, and then iterates to reduce error between the ground truth data and the estimated location. In some embodiments, the ground truth data may include hand-measured positions. In some embodiments, the ground truth data may include GPS positions and/or augmented GPS positions.

In some embodiments, the algorithm has been trained to first recognize types of motion (e.g., walking or running on a level floor, walking or running on stairs, opening doors, turning corners in hallways or stairwells, etc.) based on the IMU data, and then weight the raw IMU data based on the type of motion.

The steps may include combining 327 position data of the UWB tag and corrected IMU data to provide an estimate of a location of the target. In some embodiments, the steps may include combining position data of the UWB tag, corrected IMU data, and at least one other positional data source (such as GPS data, and/or data from a camera-based simultaneous localization and mapping (SLAM) system, etc.) to provide an estimate of a location of the target.

In some embodiments, combining the position data and the corrected IMU data includes utilizing a Kalman filter. Such approaches are well-understood in the art.

In some embodiments, combining the position data and the corrected IMU data includes selecting data (and/or weighting data) based on confidences.

In some embodiments, the combining step may include determining a confidence of the position data (which may have been done previously), and either selecting only the position data when the confidence of the position data is greater than or equal to a threshold confidence or selecting only the corrected IMU data when the confidence of the position data is less than the threshold confidence. For example, in some embodiments, the received signal strength indicator (RSSI) of the UWB signal is used to determine confidence—when the RSSI is below a threshold level, the system may select and/or weight the IMU data preferentially compared to the UWB position data. Some quality metrics used to determine a confidence may utilize individual signal properties (e.g., peak power) and/or entire signals (e.g., a transmission's spectral shapes).

In some embodiments, the combining step may include determining a confidence of the position data of the UWB tag and a confidence of the corrected IMU data (which may have been done previously), and (a) selecting only the position data when the confidence of the position data is greater than or equal to a first threshold confidence, (b) selecting only the corrected IMU data when the confidence of the position data is less than the first threshold confidence and the confidence of the corrected IMU data is greater than or equal to a second threshold confidence; or (c) utilizing a Kalman filter to combine the position data and the corrected IMU data when the confidence of the position data is less than the first threshold confidence and the confidence of the corrected IMU data is less than the second threshold confidence.

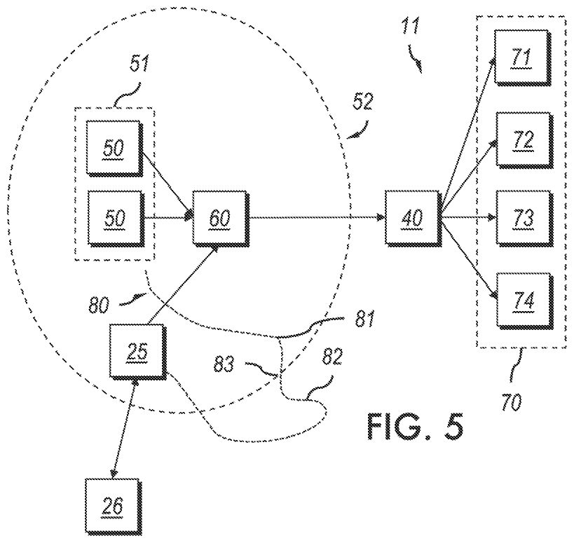

An example of this selecting via confidence approach can be seen in reference to FIG. 5. There, UWB anchors 50 (e.g., mounted on a vehicle 51) are shown, the UWB anchors providing an area of UWB coverage 52. Target 25 is moving on a path 80. When target 25 at a first point 81 within the coverage area 52, the UWB position data would be selected. When the target crosses the boundary of the coverage area at a point 83, the confidence in the UWB position data would be below a threshold, and the system would switch to using IMU data. So, when the target reaches second point 82, the system is determining location using the IMU data. As the target moves in an out of the coverage area, the system would automatically switch from using IMU data for determining position to using UWB data, or vice-versa, as appropriate. The UWB data and IMU data may, e.g., be sent to a gateway 60 that passes the information to processors within a remote housing 40, and the remote processors would then determine confidences and make the necessary selections.

In some embodiments, the estimate of the location of the target may use an alignment reference of the position data as an alignment reference of the estimate of the location of the target. For example, in some embodiments, the absolute global position of the target may be less important than a position relative to an on-site location. In some embodiments, the location of the target may be determined relative to, e.g., one of the UWB anchors mounted on a fire truck, or a particular location on a vehicle.

In some embodiments, the estimate of the location of the target may use GPS data as an alignment reference of the estimate of the location of the target.

The steps may include generating 328 a message in a serialized message stream containing the estimate of the location of the target. Any appropriate serialization scheme is contemplated.

In some embodiments, the message may contain the estimate of the location of the target, as well as additional information, such as a unique identifier associated with the target. In some embodiments, each user of a system may have their own stream. In some embodiments, all users of a system may use the same stream.

Referring to FIG. 4, the third group of steps 330 is typically performed by a remote device. Referring to FIG. 5, in some embodiments, the system may include one or more remote devices. 70. The remote devices may include, e.g., a smartphone or tablet, a laptop computer, a desktop computer, or an AR headset or AR glasses.

Each remote device may be configured to first receive 331 each message in the serialized message stream. The messages are then processed, and the remote device then graphically displays 332 the estimated of the location of the target.

In some embodiments, the remote device may be the same AR headset or AR glasses that is operably coupled to the target 25. In some embodiments, every member of a first response team is part of the system, so every member can see the location of every other member of the team.

As seen in FIG. 5, in some embodiments, devices coupled to members of a first response team 25, 26, may form a network, such as a mesh network, to ensure every UWB tag and IMU can communicate with the remote processor in the remote housing 40. This may be implemented in any appropriate manner.

For example, in some embodiments, devices on targets and the remote processor are each configured to periodically communicate with each other. The remote processor may be configured to periodically send a verification packet to a device coupled to each target, indicating whether it has received any communications from the device within a predetermined period of time. If the device coupled to a second target 26 has not received any communications from the remote processor in a predetermined period of time (say, 30 seconds), or if the verification packet indicates the remote processor has not received any communications from the device recently, the device coupled to the second target 26 may stop trying to communicate directly, and may instead send data to the first target 25 for forwarding to the remote processor, where the remote processor will recognize the data is being forwarded, and will now communicate to second target 26 through first target 25. Second target 26 may then periodically try to communicate directly with the remote processor until two-way communication is re-established.

### Example 1

A fire truck responding to a house fire arrives on the scene of a fire. Four UWB anchors as disclosed herein and a smart gateway are installed on the truck. The firefighters on board either already have UWB tags in a coat pocket, or they grab them out of a charger, e.g., in the cabin of the truck. The tracking system automatically begins tracking everyone as soon as they leave the truck, and their position is visible on a rugged laptop in the truck. The firefighters enter the building and discover the source of the fire is the boiler in the basement. The UWB tags track them as long as possible but eventually lose signal as they go below grade and behind an interior concrete wall in the basement. But the IMU-based tracking continues to calculate their positions and stream it back with our wall penetrating Lora radios.

Meanwhile, a Chief Officer arrives on the scene and can immediately see the position of all firefighters that were on the truck. The chief office has a computer that automatically connected to the on-scene truck and began pulling position data.

Because the neighborhood had 5G access, the tracking system was also streaming positions of all on-scene personnel up to the cloud, making it visible to a Fire Operation Center located several miles away. If additional departments are called in to help, this backend link would connect all of the tracking systems to provide one common operating picture, e.g., to any Commanders.

In this example, for the UWB system, a devkit from Qorvo was chosen. A specialized interface to the UWB tags to gain access to specific features. One tag was configured as a “listener”, and it was connected to a Linux laptop via USB serial. Then some software in C++ called Serial was written that listens for incoming tag position updates. These updates happen once a second or once every ten seconds, depending on whether the tag moves. Next, Serial packages this position data in a Google Protocol buffer and sends it out over a ZMQ socket. An application in Unity was written to receive the location data and graphically render the tag's position in 3D space. The Unity application used a dual stereoscopic interface so the user can visualize 3D data from both eyes.

This approach of using protocol buffers and ZMQ offers several advantages. First, both have implementations across most major platforms and languages. This gave us the flexibility to write in C++, Python, and Java for Android yet still seamlessly connect. Another benefit to this approach is that in ZMQ, one can create publisher and subscriber sockets. These sockets allow one to publish position data and let several viewers subscribe and render the data. These viewers could be a local process used to show a real-time graph of the incoming data for debugging, or it could be a remote software on a tablet, PC, phone, or headset. Finally, it gives great flexibility in designing and combining components, even potentially from other vendors.

### Example 2—UWB Testing

Initial results from UWB testing were quite poor. At twelve meters from the outside of a dwelling, the tags could not penetrate the outer wall (brick façade, vinyl siding, and glass). The design of the tags was examined, and it was determined they are not optimized for this application. First, their power was limited to FCC limits for fixed position tags. They were configured to a high bitrate and had no LNA (low noise amplifier) in front of their receiver. Each of these factors contributes to the tag's ability to pass through walls.

After modifying the transmit power, a considerable improvement was seen, and the tags could be tracked inside the dwelling. The results were very repeatable. Measuring the known (hand-measured) location points against the plotted UWB tracking positions showed us an accuracy of 1-3 meters.

In some embodiments, the tags are modified to have lower bit rates, along with having an LNA added to the front end of the tags and anchors. The LNA has the same effect as boosting the power but without the increased emissions.

### Example 3—AI-Enhanced IMU

As disclosed herein, UWB by itself will not track responders in every situation. It is suspected that below grade and multiple walls will make the tags difficult, if not impossible, to track wirelessly.

The second part of the tracking system uses an AI-enhanced IMU tracker. An IMU may consists of, e.g., a gyroscope, accelerometer, and compass, which can be used together to track movement and position by integrating over time. Typically, the noise and drift of these devices cause any absolute tracking algorithm to fly off course rapidly. These error sources are one of the reasons other non-GPS tracking systems are conventionally referred (e.g., cameras are used in Third Eye's simultaneous localization and mapping (SLAM) technology, or for devices using visual inertial odometery (VIO) techniques).

In the disclosed approach, raw IMU data is streamed back to a remote processor, where it is run through an artificial intelligence (AI) algorithm that counters the effects of noise, drift, and/or error to output a clean real-time position.

It is worth noting that the disclosed solution does not require the tag or device to be worn in a certain way, such as on the boot or strapped to the arm. In this example, a tester simply grabbed an android-based phone as the remote IMU, dropped it in a pocket, and start recording.

Android phones were used as the remote IMUs since they include an IMU with the same functionality we disclose herein, albeit at a lower quality than would be preferred for a first responder. First, an Android app was designed that continuously records raw IMU data. Raw gyroscope, accelerometer, rotation vector, and compass data was recorded. Then, every second, this data is packaged up into a google protocol buffer and sent to a remote server over a ZMQ socket.

A remote Python server receives the IMU data in real-time and stores it in a concurrent queue. Then a separate process consumes the queue data and pre-processes the data in two-second chunks. The rotation vector is applied to the raw IMU data to make the system invariant to the phone position. Next, the data is time-synchronized and interpolated before being fed into the AI model. The model puts out position data which can then be graphed and recorded in real-time. The position data may also be made available on a ZMQ socket so that any visualization program can subscribe and begin plotting.

The results for a system that only tracks with IMU data were surprisingly comparable to the UWB tracking accuracy and repeatability, but the IMU data would work indoors as well as outdoors. Geographic points were hand-surveyed using measuring tapes and rollers and GPS coordinates of, e.g., the center of a front door of a dwelling as a reference.

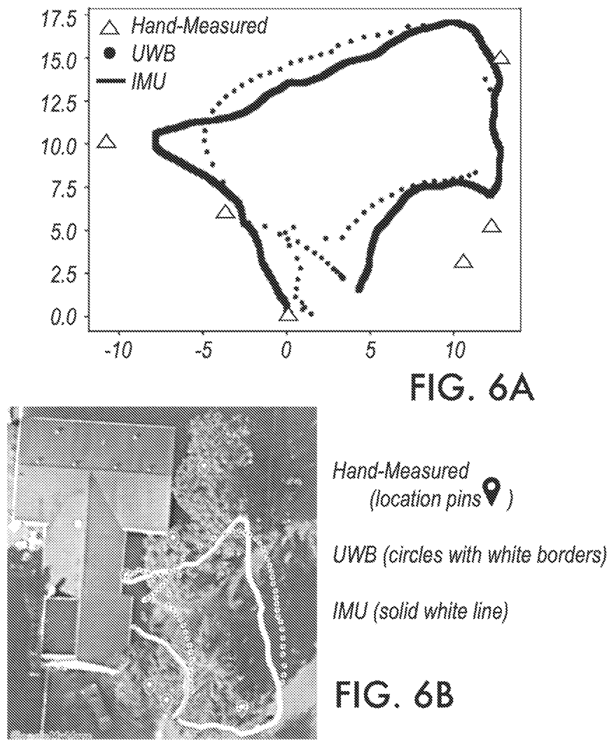

A comparison of outdoor-only data can be seen in FIGS. 6A and 6B. In FIG. 6A, the system utilizes a hand-surveyed point of the front door of a dwelling as the reference point for the data being presented, while in FIG. 6B, the system utilizes GPS data as the reference point, and the system overlays the position data onto map data (e.g., satellite imagery).

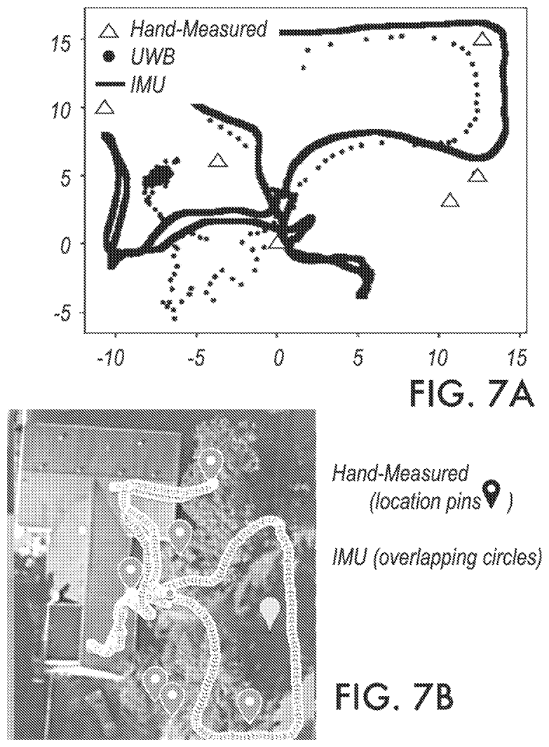

In FIGS. 7A and 7B, a similar comparison is made. In FIG. 7B, only the IMU-only data is shown, and the data includes both indoor and outdoor data. Looking at FIG. 7A, it can be seen that while the path shape was correct, the IMU-only data is offset. As such, in FIG. 7B, that error makes some of the indoor path appear outdoors, which highlights the need for increased accuracy.

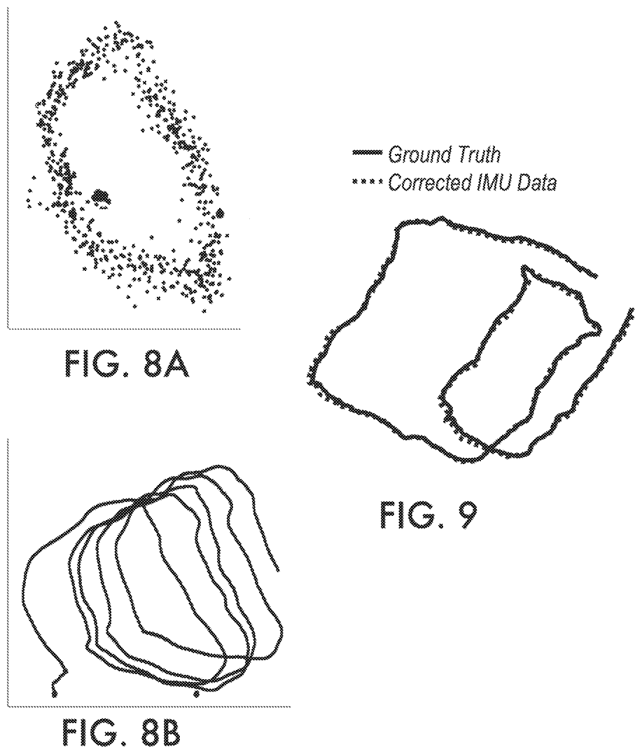

This error can better be understood with reference to FIGS. 8A and 8B. In these figures, two 5-minute tests were performed, one with UWB only, and one with IMU only. Both tests were performed at a test home with UWB anchors installed on poles outside. A circular path defining a simple loop was followed indoors. The same walking path was used for both tests.

For the UWB test, a target walked the same circular path for five minutes. As seen in FIG. 8A, the plot of data (on arbitrary axes) remains in a circular pattern with no drift seen. Total distance travelled was approximately 200m with each loop being approximately 16.46m in length. To calculate error, two known points were measured—the starting point and the center point of a second doorway behind one of the interior walls. The data was plotted, and the worst-case points at those two measured points were selected. The starting point had an error of 0.57m and our far door point had an error 0.846m.

In the IMU-only test, the same loop was walked for almost two minutes, with a distance of 40m. The IMU outputs drifted over time as can be seen FIG. 8B. This is expected as position from IMU data is velocity integrated over time so errors will compound over time.

After the data shown in FIGS. 7A-8B were collected, it was determined that a bug in the software existed, where dropped sample points were causing the IMU timing to be off, resulting in the correct shape but incorrect scale. As seen in FIG. 9, after the bug was corrected, the AI model was able to provide accurate, corrected IMU data, resulting in position data that matched the ground truth with little error.

To improve accuracy over what was seen in the above-described examples, several options may be considered.

First, for the UWB tags, the anchor positions may be measured and calibrated manually. Especially as they may be installed on, e.g., the side of first responder vehicles, this will improve accuracy. The UWB tags in use in the examples disclosed previously herein used TDoA (time difference of arrival), so things like antenna delay, position, and reference time all affected the accuracy. The literature indicates such tags are capable of being adjusted to 20 cm accuracy, so proper calibration should improve accuracy. Additionally, using a selectable antenna, an LNA, and adjustable bit rate may improve performance as well.

For IMU accuracy improvements over what is provided in this example, two options may be considered.

First, raw sensor data can be improved—preferably, an IMU with lower noise and higher accuracy than is present in existing android-based phones should be used.

Second, as disclosed herein, the system may combine IMU with the UWB data to let the system track in areas where UWB does not work, and the fusion, such as when incorporating a Kalman filter, will improve overall position error.

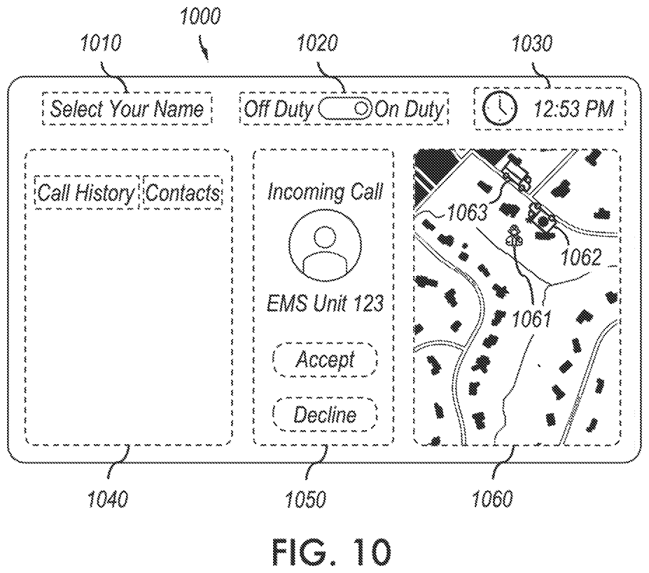

In some embodiments, a visualization front-end is provided. In some embodiments, the remote devices that receive the serialized message stream may use the front-end to coordinate first responders. An example of such a front-end, FIG. 10 shows an example graphical user interface that may be utilized. As seen, the user interface 1000 includes several areas. A first area 1010 may allow a user to log in, log out, and/or select their name. This may include, e.g., a drop-down menu. A second area 1020 may allow a user to indicate whether they are on- or off-duty, and may include, e.g., a toggle switch. A third area 1030 may show a time. In some embodiments, this may be a local time. In some embodiments, it may be the time wherever the serialized message streams are coming from. In some embodiments, it the time of a fixed city or time-zone (e.g., it may be set to the current time in New York City). A fourth area 1040 may show a call history and/or contacts, and may include one or more buttons for switching between the two. A fifth area 1050 may be for audio- or video-calls. For example, incoming calls may show in this area, along with buttons allowing a user to accept or decline the call. In some embodiments, this area may overlap other areas of the screen, and may only appear when a call is in-progress. A sixth area 1060 may show a map. The map may show current locations of, e.g., individual first responders 1061, or locations of vehicles 1062, 1063.

In some embodiments, when a contact is selected in the fourth area 1040, the map centers on the location of the first responder and/or vehicle associated with the contact. In some embodiments, when a request for an audio- or video-call is received, the map centers on the location of the first responder and/or vehicle associated with the incoming call.

In some embodiments, the map may be configured to show the time-stamped location history of the first responders and/or vehicles. In some embodiments, the time-stamped location history can be used to confirm, e.g., total response time, time of arrival on a scene of a fire, etc. In some embodiments, the time stamped location history may be useful to, e.g., optimize routing for other first responders who may arrive later at the scene.

While the invention is described through the above-described exemplary embodiments, modifications to, and variations of, the illustrated embodiments may be made without departing from the inventive concepts disclosed herein. For example, although specific parameter values, such as dimensions and materials, may be recited in relation to disclosed embodiments, within the scope of the invention, the values of all parameters may vary over wide ranges to suit different applications.

As used herein, including in the claims, the term “and/or,” used in connection with a list of items, means one or more of the items in the list, i.e., at least one of the items in the list, but not necessarily all the items in the list. As used herein, including in the claims, the term “or,” used in connection with a list of items, means one or more of the items in the list, i.e., at least one of the items in the list, but not necessarily all the items in the list. “Or” does not mean “exclusive or.”

Disclosed aspects, or portions thereof, may be combined in ways not listed above and/or not explicitly claimed. In addition, embodiments disclosed herein may be suitably practiced, absent any element that is not specifically disclosed herein. Accordingly, the invention should not be viewed as being limited to the disclosed embodiments.

What is claimed is:

1. A system for tracking locations, comprising:
an ultrawideband (UWB) tag operably coupled to a target, the UWB tag operably communicating with a remote processor;
an inertial measurement unit (IMU) operably coupled to the target, the IMU operably communicating with the remote processor; and
a non-transitory computer readable storage medium containing instructions that, when executed, cause the remote processor to:
receive position data of the UWB tag;
receive raw IMU data from the IMU;
create prepared IMU data for use with a trained algorithm by processing the raw IMU data;
generate corrected IMU data by using the trained algorithm to remove at least some drift, noise, and/or error from the prepared IMU data;
determine a confidence of the position data of the UWB tag;
based on the confidence, combine position data of the UWB tag and corrected IMU data to provide an estimate of a location of the target; and
generate a message in a serialized message stream containing the estimate of the location of the target.

2. The system according to claim 1, wherein the position data and raw IMU data are sent to the remote processor over a ZMQ socket.

3. The system according to claim 2, wherein the remote processor receives position data once every 1-10 seconds and raw IMU data once per second.

4. The system according to claim 3, wherein the UWB tag and the IMU are incorporated in a single device.

5. The system according to claim 4, wherein the single device is an augmented reality (AR) headset or AR glasses.

6. The system according to claim 5, wherein the AR headset or AR glasses comprises at least one processor operably coupled to the UWB tag, the IMU, and a display, where the display is operably coupled to a headset configured to be placed in front of a user's eyes.

7. The system according to claim 6, wherein a second AR headset or AR glasses is configured to receive the serialized message stream and graphically display a position of the target on a display of the second AR headset or AR glasses.

8. The system according to claim 7, wherein the single device further comprises a radio with a range of 3-10 miles line-of-sight, and a bandwidth less than 30 kbits/sec.

9. The system according to claim 8, further comprising one or more remote devices, each remote device configured to:
receive each message in the serialized message stream; and
graphically display the estimated of the location of the target.

10. The system according to claim 9, further comprising a UWB anchor, the UWB tag configured to communicate with the UWB anchor, and the UWB anchor configured to communicate directly or indirectly with the remote processor.

11. The system according to claim 10, wherein the remote processor is configured to:
receive global positioning system (GPS) data from a GPS sensor operably coupled to the target, or from a GPS sensor coupled to a vehicle; and
combine position data, corrected IMU data, and GPS data to provide an estimate of a location of the target.

12. The system according to claim 11, wherein the message contains the estimate of the location of the target, and a unique identifier associated with the target.

13. The system according to claim 12, wherein causing the remote processor to create prepared IMU data includes cause the remote processor to:
store the raw IMU data in a concurrent queue;
generate intermediate IMU data by pre-processing the raw IMU data from the concurrent queue in two-second chunks and applying a rotation vector to the raw IMU data to render it invariant to the IMU position; and
time-synchronize and interpolate the intermediate IMU data.

14. The system according to claim 13, wherein causing the remote processor to combine the position data and the corrected IMU data includes utilizing a Kalman filter.

15. The system according to claim 14, wherein causing the remote processor to combine the position data and the corrected IMU data includes causing the remote processor to:
select only the position data when the confidence of the position data is greater than or equal to a threshold confidence; and
select only the corrected IMU data when the confidence of the position data is less than the threshold confidence.

16. The system according to claim 14, wherein causing the remote processor to combine the position data and the corrected IMU data includes causing the remote processor to:
select only the position data when the confidence of the position data is greater than or equal to a first threshold confidence;
select only the corrected IMU data when the confidence of the position data is less than the first threshold confidence and a confidence of the corrected IMU data is greater than or equal to a second threshold confidence; and
utilize a Kalman filter to combine the position data and the corrected IMU data when the confidence of the position data is less than the first threshold confidence and the confidence of the corrected IMU data is less than the second threshold confidence.

17. The system according to claim 14, wherein the estimate of the location of the target uses an alignment reference of the position data as an alignment reference of the estimate of the location of the target.

18. The system according to claim 14, wherein the estimate of the location of the target uses global positioning system (GPS) data as an alignment reference of the estimate of the location of the target.

19. A method for estimating locations, comprising:
receiving position data from a UWB tag operably coupled to a target;
receiving raw IMU data from an IMU;
creating prepared IMU data for use with a trained algorithm by processing the raw IMU data;
generating corrected IMU data by using the trained algorithm to remove at least some drift, noise, and/or error from the prepared IMU data;
combining position data and corrected IMU data to provide an estimate of a location of the target, based on a determined confidence in the IMU data; and
generating a message in a serialized message stream containing the estimate of the location of the target.

20. A kit, comprising:
a device containing a UWB tag and an IMU;
a UWB anchor; and
a gateway configured to be coupled to the UWB anchor and to communicate with a remote server using a ZMQ socket.
